(19) United States
(12) Patent Application Publication
(10) Pub. No.: US 2003/0113433 A1
(43) Pub. Date: Jun. 19, 2003

(54) Minced or ground meat chip

(76) Inventor: Daryl L. Tempesta, Scotts Valley, CA (US)

Correspondence Address: Jeffrey A. Hall, 212 Clinton Street, Santa Cruz, CA, 95062, US

(21) Appl. No.: 10/024,028

(22) Filed: Dec. 18, 2001

(51) Int. Cl. A23L 1/31

(52) U.S. Cl. 426/646

(57) ABSTRACT

A dried minced or ground meat product, comprising: a cut or slice of a piece of a minced or a ground meat, such as sausage, salami, pepperoni, or the like, is dried using a microwave, gas, solar, or electric oven, so that fat and moisture are removed from the piece of minced or ground meat. The dried piece of minced or ground meat has a substantially lower fat and water content than the minced or ground meat and may be configured as a chip, a stick, or other desired geometric configuration. The dried piece of minced or dried meat is consumable alone or in combination with other food products.

### BACKGROUND OF THE INVENTION

1. Field of Invention

This invention relates to sausage, salami, pepperoni, and other ground or minced meats, and more particularly to a dried chip derived from such meats which has a very low fat content and is delicious to eat.

2. Description of the Related Art

Various minced or ground meats have been prepared and eaten throughout human history. Such meats have included beef, pork, lamb and the like, have been prepared with and without seasonings. Examples of such meats are sausage, salami and pepperoni. Usually such meats are prepared by mincing or grinding of the meat and then adding salt and/or other seasonings and then consumed.

The present invention is a dried minced or ground meat product, such as salami, sausage, or pepperoni, prepared as a dried chip or other configuration, such as a stick, square, or the like, which is low in fat, crisp, highly storable, accepts a wide variety of flavorings, and is delicious to consume.

Accordingly, it is the primary object of this invention to provide a minced or ground meat chip, such as a pepperoni chip, and method of making the same which is low in fat, easy to prepare, stores well, accepts a wide variety of flavorings, and can be eaten cold, or combined with other foods such as pizza. The present means and method disclosed herein may also be used with other minced or ground meats such as sausage, salami, and the like.

Additional objects and advantages of the invention will be set forth in the description which follows, and in part will be obvious from the description, or may be learned by practice of the invention. The objects and advantages of the invention may be realized and obtained by means of the instrumentality's and combinations particularly pointed out in the appended claims.

### SUMMARY OF THE INVENTION

To achieve the foregoing objects, and in accordance with the purpose of the invention as embodied and broadly described herein, a dried minced or ground meat product is provided comprising, a cut or slice of a piece of a minced or a ground meat, such as sausage, salami, pepperoni, or the like. The cut or slice of minced or ground meat is then dried using a microwave, gas, solar, or electric oven, so that substantial amounts of fat and moisture are removed from the piece of minced or ground meat. The dried piece of minced or ground meat has a substantially lower fat and water content than the minced or ground meat and may be configured as a chip, a stick, or other shape or desired geometric configuration. The dried piece of minced or dried meat is consumable alone or in combination with other food products.

### DESCRIPTION OF THE PREFERRED EMBODIMENTS

Reference will now be made in detail to the present preferred embodiments of the invention.

In accordance with the present invention, there is provided in a preferred embodiment of the invention, a dried minced or ground meat product comprising a cut or slice of a piece of a minced or a ground meat, such as sausage, salami, pepperoni, or the like. The cut or slice of minced or ground meat is then dried using a microwave, gas, solar, or electric oven, so that substantial amounts of fat and moisture are removed from the piece of minced or ground meat, resulting in a dried piece of minced or ground meat. The dried piece of minced or ground meat has a substantially lower fat and water content than said minced or ground meat, and is accordingly a more nutritious and healthy product than the minced or ground meat product. and may be configured as a chip, a stick, or other shape or desired geometric configuration. The dried piece of minced or dried meat is consumable alone or in combination with other food products. If desired, various spices or sauces may be combined or consumed with the dried meat product, for example, salt, pepper, garlic, salsa, and other well known pieces and sauces may be used. Or the meat may be combined with soy or other plant based products.

Preferably, in preparing the dried minced or ground meat product of the present invention, a sausage, salami, or pepperoni is sliced or otherwise cut to a desired thickness and size. The size and type of cut is determined by what is desired as an end product, that is , a chip, a stick, a cube, powdwe, particulate, or the like.

The slice or cut of the minced or ground meat is then placed in a drying means such as a microwave oven, a gas oven, solar oven, an electric oven, or other drying means, and dried until a substantial amount of the water and fat is removed form the minced or ground meat product. The extent of drying may be varied depending upon the fat and water content of the minced or ground meat, and the desired fat and moisture content of the dried product. Preferably, between ten percent and ninety nine percent fat is removed prior to termination of the drying process, and between ten percent and ninety nine percent of the water content is removed from the minced or ground meat prior to termination of the drying process.

In operation and use, the dried minced or ground meat product of the present invention provides a nutritious, low fat, delicious, and easily stored product. The dried sausage, salami, or pepperoni may be combined with various spices, sauces and flavorings, if desired, or consumed alone.

Additional advantages and modification will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept.

What is claimed is:

1. A dried minced or ground meat product, comprising:
a cut or slice of a piece of a minced or a ground meat is dried using heat means for drying, removing fat, and removing moisture from said piece of minced or ground meat, said dried piece of minced or ground meat having a substantially lower fat and water content than said minced or ground meat; said dried piece of minced or dried meat being consumable alone or in combination with other food products.

2. The dried minced or ground meat product of claim 1, wherein said dried piece of minced or ground meat is configured as a chip.

3. The dried minced or ground meat product of claim 1, wherein said dried piece of minced or ground meat is configured as a stick.

4. The dried minced or ground meat product of claim 1, wherein said piece of minced or ground meat is pepperoni.

5. The dried minced or ground meat product of claim 1, wherein said minced or ground meat is salami.

6. The dried minced or ground meat product of claim 1, wherein said minced or ground meat is a sausage.

7. The dried minced or ground meat product of claim 1, wherein said heat means for drying said piece of said minced or ground meat is a microwave oven.

8. The dried minced or ground meat product of claim 1, wherein said heat means for drying said piece of said minced or ground meat is a gas heated oven.

9. The dried minced or ground meat product of claim 1, wherein said heat means for drying said piece of said minced or ground meat is an electric oven.

10. A method of making a dried minced or ground meat product, comprising:
preparing a piece of minced or ground meat from sausage, salami, or pepperoni, and
cooking said piece of minced or ground meat until a substantial percentage of fat is removed form said minced or ground meat piece and said piece of minced or ground meat is substantially dry.

11. The method of claim 10, wherein said piece of minced or ground meat is configured as a chip.

12. The method of claim 10, wherein said piece of minced or ground meat is configured as a stick.

13. The method of claim 10, further including adding spices to said dried piece of minced or ground meat.

14. The method of claim 10, further including adding salt to said dried piece of minced or ground meat.
